(19) United States
(12) Patent Application Publication
(10) Pub. No.: US 2021/0192618 A1
(43) Pub. Date: Jun. 24, 2021

(54) FRACTIONAL SHARE SYSTEM

(71) Applicant: Emcee Invest, Inc., Brooklyn, NY (US)

(72) Inventors: Arash Asady, Brooklyn, NY (US); Ryan Gary, New York, NY (US)

(21) Appl. No.: 17/122,090

(22) Filed: Dec. 15, 2020

Related U.S. Application Data
(60) Provisional application No. 62/951,396, filed on Dec. 20, 2019.

(51) Int. Cl. G06Q 40/04; G06Q 40/00

(52) U.S. Cl. CPC G06Q 40/04; G06Q 40/12

(57) ABSTRACT

Methods, systems, and computer readable media for a fractional share system that include receiving data indicating a trigger event corresponding to a user interaction with a particular entity, wherein the trigger event triggers a market transaction to be carried out by the one or more processors on behalf of the user, determining, based on the received data, a fractional number of shares of the particular entity to obtain through the market transaction on behalf of the user, wherein the fractional number of shares differs from a whole number of shares, and generating, in response to determining the fractional number of shares, a market order for the fractional number of shares of the particular entity on behalf of the user.

### CROSS-REFERENCE TO RELATED APPLICATION

This application claims the benefit of U.S. Provisional Application No. 62/951,396, filed Dec. 20, 2019, the contents of which are incorporated by reference herein.

### BACKGROUND

This document relates to a fractional share system. Systems that provide users with shares of a company generally delay any purchase of stocks until a user has accumulated sufficient rewards to purchase a threshold amount of shares.

### SUMMARY

In general, one innovative aspect of the subject matter described in this specification can be embodied in a method that includes receiving, by one or more processors, data indicating a trigger event corresponding to a user interaction with a particular entity, wherein the trigger event triggers a market transaction to be carried out by the one or more processors on behalf of the user. The method includes determining, by the one or more processors and based on the received data, a fractional number of shares of the particular entity to obtain through the market transaction on behalf of the user, wherein the fractional number of shares differs from a whole number of shares. The method includes generating, in response to determining the fractional number of shares, a market order for the fractional number of shares of the particular entity on behalf of the user.

In some implementations, receiving data indicating a trigger event includes receiving transaction post data indicating that a transaction between the user and the particular entity has posted to a user account that is indexed to a fractional share account of the user.

In some implementations, the method further includes receiving a transaction notice indicating the transaction between the user and the particular entity has occurred, but not yet posted. The method can further include accessing a mapping of participating entities to user accounts. The method can further include determining, based on the mapping of the participating entities to the user accounts, whether the particular entity is a participating entity, and whether the user account is linked to the particular entity in the mapping. The method can further include processing the transaction notice based on the determination of whether the particular entity is a participating entity, and whether the user account is linked to the particular entity in the mapping, including triggering the market transaction when the determination reveals that the particular entity is a participating entity and that the user account is linked to the particular entity in the mapping, and not triggering the market transaction when the determination reveals that the particular entity is not a participating entity or that the user account is not linked to the particular entity in the mapping.

In some implementations, triggering the market transaction includes determining, based on a machine learning model trained on historical account data for the user account and historical market data, a market order time at which the market order will be placed, wherein the market order time is after the transaction between the user and the particular entity, but before the transaction has posted to the user account, where generating the market order comprises generating the market order at the determined market order time.

In some implementations, the method further includes determining, based on historical account data for the user, that there is an upcoming recurring transaction between the user and the particular entity. The method can further include, prior to the upcoming recurring transaction, determining, based on a machine learning model trained on historical account data for the user account and historical market data, a market order time at which the market order will be placed, wherein the market order time is prior to the upcoming recurring transaction between the user and the particular entity, where generating the market order comprises generating the market order at the determined market order time.

In some implementations, receiving data indicating a trigger event comprises receiving data indicating that the user performed a particular user interaction other than a financial transaction.

In some implementations, the method further includes determining that the particular entity has mapped the particular user interaction to a particular fractional share factor. The method can further include determining a performance level corresponding to an amount of the particular user interaction performed by the user, wherein determining a fractional number of shares of the particular entity to obtain through the market transaction on behalf of the user comprises determining the fractional number of shares based on a mathematical operation applied to the fractional share factor and the performance level.

In some implementations, the method further includes validating, by the one or more processors and using the data, the trigger event. The method can further include determining, by the one or more processors, that the trigger event has posted to the user's financial institution account, where placing the order for the predetermined portion of the share of stock for the entity is performed in response to the determination that the trigger event has posted.

In some implementations, the trigger event is participation in a program specified by the entity.

Other embodiments of this aspect include corresponding systems, apparatus, and computer programs, configured to perform the actions of the methods, encoded on computer storage devices.

Particular embodiments of the subject matter described in this document can be implemented so as to realize one or more of the following advantages. Fractional shares allow people to have ownership in corporate entities in which they would not otherwise be able to invest. By offering rewards of fractions of shares, the proposed technique engenders brand loyalty and incentivizes users to become interested in the future of the corporate entity in which they have a stake. The proposed technique offers flexibility to users—shares can be held for future sale or sold and converted to cash rewards at any time. Current systems that offer shares of corporate entities as rewards require the user to have a threshold aggregate amount of rewards, such that the user can purchase a full share of stock, prior to providing the reward to the user. The proposed technique does not force users to wait until they have accumulated sufficient rewards to purchase an entire share and instead places orders on behalf of users for fractional shares upon detecting a qualifying trigger event even if the user does not have an aggregate amount of rewards sufficient to purchase a full share of stock. The fractional nature of the system improves user experience by providing instant gratification and improves goodwill of users toward the system itself and associated corporate entities.

The system uses machine learning models that utilize historical transaction and market data. These models allow the system to predict the market activity to minimize the price at which the fractional share is obtained. The system uses these predictions to determine an optimized time at which to place the orders for the fractional shares. For example, the system is able to place an order between a time that a qualifying trigger event, such as a purchase, has occurred and the time at which the purchase posts to the user's account. This period of time allows the system to predict the amount of funds available within the system for placing market orders on behalf of users of the system and allows the system to adjust its market order strategy to reduce transaction costs and minimize share price at the time of purchase. Furthermore, the machine learning system can be utilized to extend the period of time for purchasing the fractional shares to even before the qualifying trigger event, for example, when the machine learning model can determine that the qualifying trigger event will happen with a specified level of confidence. Thus, the system need not even wait for the qualifying triggering event before acquiring the fractional shares.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a user's actions trigger a market order of a fractional number of shares on behalf of the user.

FIG. 2 is an example data flow for submitting a market order for a fractional number of shares on behalf of a user in response to a verified trigger action.

FIG. 3 is a flow chart of an example process for generating a market order for a fractional number of shares on behalf of a user in response to a verified trigger action.

FIG. 4 is a block diagram of an example computing system.

Like reference numbers and designations in the various drawings indicate like elements.

### DETAILED DESCRIPTION

This document describes methods, systems, and devices that reward users for brand loyalty and for performing non-transactional activities designated as qualifying trigger actions, such as participating in a recycling program, volunteering for a cause, or interacting with an online presence of an entity, among other activities. Users are rewarded with fractional portions of shares in a particular corporate entity with which the user has had a qualifying interaction or for whom the user has performed a qualifying trigger action. The proposed techniques facilitates the retention of existing users and the acquisition of new users who are interested in the benefits offered through the proposed reward system.

Users may be an individual, a corporation, or any other legal entity capable of purchasing goods or services. Users become eligible for fractional share rewards by performing qualifying trigger events that are specified by a participating corporate entity through the use of a payment method such as a financial institution account that has been authenticated and linked to the user's reward system account. The issuance of the share rewards involves the establishment of an agreement between the corporate entity and the user. This agreement stipulates the criteria and for and the formula whereby the user earns share rewards.

Rewarding users for brand loyalty is an important tool in growing and maintaining a customer base. Providing users with equity ownership in entities they patronize is an effective way to help users feel invested in the success of the entity. The more a user supports and interacts with a corporate entity, the larger their participation in the corporate entity, providing a positive feedback loop that encourages further patronage and interaction with the corporate entity. Existing systems offer shares in exchange for purchases once a user has accumulated enough to purchase a full share of stock. However, waiting to accrue enough to purchase a sufficiently large portion to offset transactions costs for a system can result in losses for a user.

The proposed techniques and systems receive data about either a transaction or action that triggers reward for user. The proposed techniques can include checking the validity of the trigger to confirm that the user should be rewarded. The amount of shares with which the user should be rewarded and the entity for which the shares are issued is calculated based on the trigger. If the trigger event is a purchase transaction, once the transaction has posted to the user's account, these shares, in the determined amounts, are ordered and distributed to the user's brokerage account. In some implementations, the amount of shares with which each user should be rewarded are aggregated across the system, allowing the purchase of a larger amount of shares without forcing individual users to wait until they've amassed enough rewards to purchase a full share of stock.

The proposed methods and systems can also trigger the reward based on actions other than transactions. For example, the system can reward a user based on detecting actions performed by the user, such as participation in a recycling program for a product of a corporate entity, participating in other programs supported by a corporate entity. These actions can be non-financial transactions that align with actions that corporate entities want to reinforce through the proposed rewards system.

Machine learning models can be applied to the proposed methods to predict the actions of the stock market and to schedule investment moves based on the predicted stock market actions. These predictions guide actions taken by the system, such as timing stock buys within a particular window of time. For example, stock buys can be timed within a window between when a transaction is pending and when a transaction posts to a user's account. The models can also be applied to predict, for example, the amount of funds available within the system to cover purchases at the determined time to buy stocks. These predictions can be based, for example, on historical user transaction data, subscription data, etc.

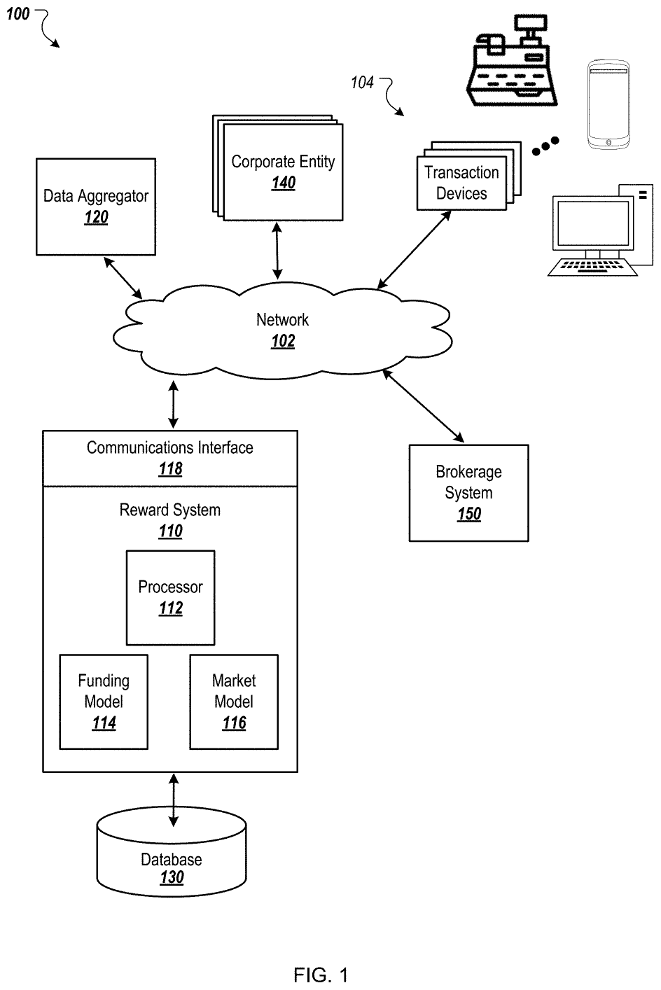

FIG. 1 is a block diagram of an example environment 100 in which a user's interactions trigger a market order of a fractional number of shares on behalf of the user. The example environment 100 includes a network 102, such as a local area network (LAN), a wide area network (WAN), the Internet, or a combination thereof. Network 102 connects transaction processing system 120, transaction device(s) 104, reward system 110, corporate entity 140, and brokerage system 150. The example environment 100 may include many different types of transaction devices 104 and corporate entities 140.

A transaction device 104 is an electronic device that is capable of requesting and receiving resources over network 102 to complete a transaction between a user and a corporate entity. Transaction device 104 provides a user with access to a corporate entity. In some implementations, transaction device 104 is, for example, a point-of-service (POS) terminal at a merchant's place of business. In some implementations, transaction device 104 is a user device through which a user can complete a transaction with a corporate entity. Example user devices 104 include personal computers, mobile communication devices, and other devices that can send and receive data over network 102. In some examples, user device 104 is a mobile device, such as a cellphone, a virtual reality device (e.g., implemented in a headset or other device such as a combination of a speaker and a display), a smartphone, a personal digital assistant (e.g., implemented in a tabletop speaker or other device such as a combination of a speaker and a display), or a tablet, and communicates over a wireless network. A user device 104 typically includes a user application, such as a web browser, to facilitate the sending and receiving of data over network 102, but applications executed by user device 104 can also facilitate the sending and receiving of data over network 102.

Brokerage system 150 facilitates the buying and selling of securities, such as debt securities, equity securities, and/or derivatives through a market. For example, brokerage system 150 can facilitate the exchange of securities through a public market such as the New York Stock Exchange, the London Stock Exchange, and the Shanghai Stock Exchange, etc. Brokerage system 150 can facilitate the exchange of securities of privately held corporates through, for example, a private market. Brokerage system 150 manages brokerage accounts of users of brokerage system 150. Currency is deposited into brokerage accounts for users to buy securities through brokerage system 150. Brokerage system 150 receives a market order and fulfills the market order by depositing ordered shares in respective users' brokerage accounts.

Corporate entity 140 is an entity that offers equity securities, such as shares of stock, through a public stock market. In some implementations, corporate entity 140 can be a privately held corporation whose shares are not traded in a stock market. Corporate entity 140 participates in the reward structure offered by system 110, and each corporate entity 140 can define trigger actions for which a user can be rewarded with shares, as well as the fractional amount of shares that a user can earn for each qualifying trigger action.

Database 130 stores brokerage account information, financial institution account information, reward system account information, and participating corporate entity information. Database 130 can store data relationally. For example, a user's brokerage account can be indexed to a verified bank account of the user's, the user's reward system account, and other user information.

Reward system 110 is a system that detects and validates user actions that trigger the system to generate and/or execute a market order. Reward system 110 facilitates the rewarding of users for their loyalty to corporate entities and other entities that offer shares of the organization. For example, reward system 110 makes it possible for entities to participate in a program that provides users with a reward of shares in the entity itself to promote loyalty and to give users a stake in the entity and its success. Users who wish to participate in reward system 110 create reward system accounts. When users create reward system accounts, they register for reward system 110 and select corporate entities from whom they would like to receive share rewards. Reward system 110 receives information, such as transaction information, and determines whether the information indicates one or more trigger actions, such as payment transactions to corporate entities. Upon detecting a trigger action related to a user and a particular corporate entity, reward system 110 determines whether the corporate entity participates in reward system 110 and whether the user has selected the corporate entity as one from whom they would like to receive share rewards.

Reward system 110 maintains accounts of participating users. Reward system 110 communicates with database 130 to store and maintain user and corporate entity accounts and information. In some situations, users may not claim their stock rewards until a brokerage account is created with reward system 110. In some implementations, in order to generate and place market orders with brokerage system 150 on behalf of users, reward system 110 must create and/or manage a brokerage account for each user. In some implementations, reward system 110 must authenticate a bank account of the user's. Further details on the authentication process are provided below. Reward system 110 can also maintain reward system accounts of users. These accounts are linked to information such as a user's brokerage account created and/or managed by reward system 110 and historical user activity information. Reward system 110 also maintains information on participating corporate entities. Reward system 110 communicates with other systems, such as transaction processing systems, third party data aggregators that securely collect and transmit user transaction data, corporate entities 140 that wish to participate in reward system 110, and users of transaction devices 104. Reward system 110 includes a processor 112, a funding model 114, a market model 116, and a communications interface 118.

Processor 112 facilitates detection and verification of trigger events performed by a user of client device 104. These events trigger the purchase of a fractional share on behalf of the user. Processor 112 determines, based on the verification of a trigger event, a fractional amount of a share to be purchased on behalf of a user who has performed the trigger event. In some implementations, processor 112 uses machine learning models to determine the optimal time to submit a market order on behalf of a user in order to minimize the cost associated with purchasing the share. These models are described in further detail below.

Trigger events, or events (e.g., a user's actions or interactions) that trigger a market order of a fractional number of shares on behalf of the user, are specified by corporate entities 140 participating in reward system 110. Actions such as purchasing items from a participating corporate entity 140 or paying a subscription fee for a product or service from a participating corporate entity 140 can be defined as trigger events. For example, an online streaming service can define payment of a monthly subscription fee as a qualifying trigger action. In some implementations, signing up for a monthly subscription to the online streaming service can be defined as a qualifying trigger action, while paying the subscription fee each month is not a qualifying trigger action. Other actions related to a participating corporate entity 140 can be designated as a trigger event, such as interacting with a corporate entity through providing feedback, participating in a survey, promotional event, or program specified by the corporate entity, and interacting with an online presence of the entity, among other user actions. For example, a particular corporate entity 140 can designate participating in a recycling program of products from entity 140 as a trigger event. These actions are non-financial in nature and relate to behavior that corporate entities want to reinforce through the proposed rewards system.

Trigger events also include actions unrelated to transactions or interactions with a participating corporate entity. For example, a particular corporate entity 140 that promotes health can designate joining any gym and attending at least five classes as a trigger event.

For some actions, the date of the transaction can differ from the date the transaction is executed. For example, a purchase made through a user's credit card may remain pending for several days before it posts to the user's account. In some implementations, the purchase can be the trigger event. For example, reward system 110 may allow corporate entities 140 to designate a purchase transaction as a trigger event as soon as a user makes a purchase and the transaction becomes pending on the user's credit card. In such situations, the transaction has not yet posted to the user's account, and thus funds have not been deducted, but the transaction has been approved. In some implementations, reward system 110 allows corporate entities 140 to designate the posting of the purchase to the user's account as a trigger event. For example, a corporate entity 140 may want to wait until funds have been deducted from a user's account before providing a reward.

Reward system 110 verifies trigger events to ensure that user actions are valid qualifying trigger events for which the user should be rewarded. Reward system 110 uses data indicating characteristics of a transaction that is detected as a trigger event and compare the data to confirmed transaction data. For example, a user can purchase a product from participating corporate entity 140 and once the transaction is marked as posted, reward system 110 detects data indicating characteristics of the purchase. Reward system 110 can then compare the detected data with confirmed details of the transaction. In some implementations, reward system 110 can compare data indicating characteristics of the trigger event with confirmed data of a later event. For example, reward system 110 can compare data of a pending transaction with the confirmed details of the transaction once the transaction has posted.

User transaction data can be kept private from reward system 110. In some implementations, reward system 110 may not directly receive user transaction data. For example, reward system 110 can detect details of the trigger event and securely access user transaction data from transaction processing system 120 to verify the detected details and the event itself. In some implementations, reward system 110 can receive a limited set of transaction data, or cleaned data. For example, reward system 110 can retrieve or request transaction data from a third party data aggregator. Further details on the verification process with data aggregator 120 are provided below.

Once a trigger event has been verified, reward system 110 determines a fractional number of shares of a particular corporate entity 140 to be provided to a user of reward system 110 as a reward. For example, users can receive a portion of their transaction amount with a participating corporate entity 140 to be used for a market order of a fractional share in corporate entity 140. For example, if a user makes a $50 purchase from a home improvement store, the home improvement store entity can offer 2% of the $50 purchase amount, or $1, to be used for a market order of a share in the home improvement store entity. The $50 purchase would result in $1 worth of corporate entity 140's stock being procured and deposited in the user's brokerage account. In some implementations, the user can choose to sell the stock and convert the share reward into a cash reward of $1 or the user can choose to keep the share for future sale.

Reward system 110 can, for example, manage users' brokerage accounts with brokerage system 150 such that an amount to be deposited in a user's brokerage account can fund the purchase of a determined fractional number of shares of a particular corporate entity 140. Reward system 110 can generate a market order for the determined fractional number of shares of the particular corporate entity 140 and provide the order to a brokerage system, such as brokerage system 150 for execution. Reward system 110 can aggregate fractional amounts of shares of particular corporate entities across all reward system accounts and generate aggregate market orders. Once the market order has been fulfilled, brokerage system 150 can deposit fractional shares in particular users' brokerage accounts.

Users select corporate entities from whom they wish to earn rewards. Users can select corporate entities from whom they wish to earn rewards through, for example, transaction devices 104. In some implementations, transaction device 104 is a user device of the user. The user can then access an account, such as an account maintained by reward system 110. In some implementations, users are limited to a predetermined number of entities from which they can earn rewards. For example, users may be limited to receiving share rewards from a total of five different entities. In some implementations, users can be limited to a particular number of entities per a category of entity. For example, users may be limited to receiving share rewards a total of two different grocery stores.

Each user's selected corporate entities are linked to the user's account by reward system 110. For example, reward system 110 can generate a mapping of participating corporate entities 140 selected by a particular user. These mappings can be stored in database 130 with other reward system account data. Reward system 110 can verify whether a user's actions qualify as a trigger action by determining whether a corporate entity indicated in received data is a participating corporate entity 140 and whether

Reward system 110 can train and implement machine learning models to predict, for example, how much funding is available to reward system 110 with which to purchase fractional shares of stock or market activity. For example, reward system 110 can train funding model 114 to predict how much funding is available to reward system 110 with which to purchase fractional shares of stock. Funding model 114 can be, for example, a neural network that receives training examples and user or transaction information as input and outputs a prediction of an amount of funding available for a market order of fractional shares of stock. Reward system 110 can train market model 116 to predict market activity, such as the trading price of particular stocks. Market model 116 can be, for example, a neural network that receives training examples and user or market information as input and outputs a prediction of an optimal time, within a period of time, at which to place a market order for one or more stocks.

Reward system 110 can gather transaction data to generate training data to input to funding model 114 and/or market model 116. Reward system 110 can select a random sample to obtain negative examples to train, for example, a neural network 114 or 116. Reward system 110 can take multiple samples of transaction data to generate one or more sets of training data.

Reward system 110 can generate training data to train a machine learning model that predicts an amount of user transactions and the corporate entity 140 associated with each transaction. For example, the machine learning model can use a recurrent neural network that is trained on historical customer transactions. In some implementations, the machine learning model can be network trained for each participating corporate entity 140. The transaction prediction machine learning model can, for example, predict an aggregate amount of rewards to be distributed to users rather than individual rewards. Reward system 110 can regularly update and/or retrain the machine learning model as the number of participating users grows. For example, reward system 110 can update the machine learning model at a periodic interval or with each new user or predetermined number of new users.

Reward system 110 can generate training data to train a machine learning model that predicts a trading price of a particular stock for a corporate entity 140. Reward system 110 can provide, for example, stock market indices and metrics such as volatility of the market (including the beta of the stock relative to the market) and the price-to-earnings ratio of the stock, among other alternative data.

Reward system 110 can, for example, update the price prediction machine learning model by implementing feature engineering, including dimensionality reduction of the machine learning model. In some implementations, reward system 110 can rank features used as input by the machine learning model or perform hyperparameter optimization. For example, reward system 110 can tune hyperparameters within a neural network used by the price prediction machine learning model based on factors such as dropout rate, layer size, and biases, among other factors.

Reward system 110 can use gradient descent, simulated annealing, and genetic algorithms, among other methods, to optimize a particular objective function of the machine learning models of reward system 110.

When generating the set of training data, reward system 110 selects training features used within the set of training data from historical transaction data. Reward system 110 determines training example weights in one of several ways. In some implementations, reward system 110 can weight each training example equally, and sample only data points within a predetermined period of time. In some implementations, reward system 110 can use decay functions to weight training examples differently depending on how recent the example is.

The system can split training, validation, and generating test data into various percentages of modelling time and resources. The system can also cross validate the output of the model.

Reward system 110 receives the training data and trains a machine learning model to determine an amount of funding available to reward system 110 to place market orders a time at which. The machine learning model may use any of a variety of techniques such as decision trees, linear regression models, logistic regression models, neural networks, classifiers, support vector machines, inductive logic programming, ensembles of models (e.g., using techniques such as bagging, boosting, random forests, etc.), genetic algorithms, Bayesian networks, etc., and can be trained using a variety of approaches, such as deep learning, association rules, inductive logic, clustering, maximum entropy classification, learning classification, etc. In some examples, the machine learning model uses supervised learning. In some examples, the machine learning model uses unsupervised learning. The machine learning model can also use wide and deep learning, long short-term memory modeling, boosting, matrix factorization, user embedding, or item embedding.

Communications interface 118 provides a connection between rewards system 110 and users of the system, such as corporate entities 140 and transaction devices 104. Communications interface 118 allows, for example, processor 112 to communicate with other devices through network 102.

Data aggregator 120 aggregates account and transaction data for users. Data aggregator 120 is a third party system that securely stores, analyzes, and transmits account and transaction information. Data aggregator 120 can be a third party system that acts as a middleman between a transaction processing system or account issuer and reward system 110. Transaction data can indicate details of transactions such as payments in exchange for goods or services from a corporate entity, such as corporate entity 140. Data aggregator 120 can receive, for example, transaction data over a secure network connection from a credit card provider that processes credit card transactions and then securely transmit at least a portion of the transaction data to reward system 110. Account data can indicate account information such as a user's bank account number and routing number. Data aggregator 120 can receive, for example, account data over a secure network connection from a financial institution that issues accounts and/or credit to users and then securely transmit the information to reward system 110. Data aggregator 120 can anonymize data prior to transmitting the data to reward system 110. For example, data aggregator 120 can encrypt or remove personally identifiable data from account and/or transaction data prior to securely transmitting the data to reward system 110.

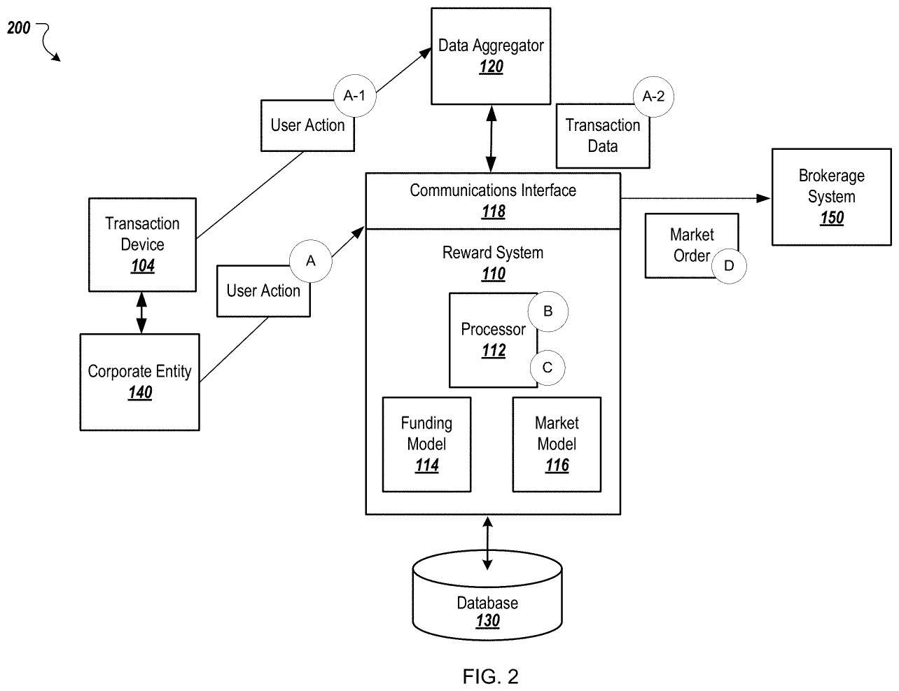

FIG. 2 is an example data flow 200 for generating a market order for a fractional number of shares on behalf of a user in response to a verified trigger action in the example environment of FIG. 1. Operations of the data flow 200 are performed by the reward system 120. Stages of the flow 200 are performed within a network environment, such as the environment 100.

In order to generate and place market orders on behalf of a user with brokerage system 150, reward system 110 creates and/or manages a brokerage account for the user. The fractional shares for which reward system 110 generates and places market orders on behalf of users can be deposited in the respective user's brokerage account. In order to create a brokerage account on behalf of a user, reward system 110 must verify the user's identity to reduce the likelihood of fraudulent activity. Reward system 110 can verify a user's identity by, for example, authenticating a bank account of the user. In some implementations, reward system 110 can securely authenticate the user's bank account without directly accessing the user's bank account. A user can enter account credentials through a third party data aggregator, such as data aggregator 120, and data aggregator 120 can securely transmit account information, including account information not entered by the user, to reward system 110. For example, a user can provide log in information for their bank account to data aggregator 120 and data aggregator 120 can securely transmit the account number and routing number to reward system 110, authenticating the user's bank account without providing the log in information directly to reward system 110.

Reward system 110 can be used with any bank account, and can include an application programming interface (API) that allows reward system 110 to be used by different systems and corporate entities to detect when an action that qualifies as a trigger event is performed. For example, rewards system 110 may be implemented as an open source system that can be integrated with multiple different transaction processing platforms.

Reward system 110 includes fraud detection and prevention measures. To ensure that only one user receives rewards from any given transaction, reward system 110 includes authentication measures that prevent a financial institution account from being associated with more than one reward system account. For example, reward system 110 can determine, based on stored mappings and/or indexing within database 130, whether a financial institution account is already associated with a particular reward system account before mapping the financial institution account to a reward system account. Reward system 110 can also detect whether a financial institution account is mapped and/or indexed to more than one reward system account and present mitigation options to both account holders.

Data flow 200 begins with stage (A), in which a user action specified as a trigger action, is detected by reward system 110, or stages (A-1) and (A-2) in which a user transaction with a corporate entity is detected by reward system 110.

In stage (A), a user action specified as a trigger action by corporate entity 140 is detected by reward system 110. In some implementations, reward system 110 receives data indicating a verified trigger action through corporate entity 140. For example, if a reward system 110 user links their frequent flyer account to reward system 110 and the account is authenticated, trigger actions can be detected and verified by corporate entity 140. Corporate entity 140 can specify, for example, that reaching a certain number of frequent flyer miles within a period of time, flying a certain number of legs, among other activities, qualify as trigger actions for which a user can be rewarded with fractional amounts of shares in corporate entity 140. In another example, a reward system 110 user can link their corporate entity 140 branded credit card to reward system 110. Once the credit card account is authenticated, for example, through data aggregator 120, reward system 110 can reward qualifying purchases made using the linked credit card with fractional amounts of shares of corporate entity 140 in addition to the existing benefits of the branded credit card.

In some implementations, reward system 110 receives data from corporate entity 140 indicating the trigger action. For example, corporate entity 140 can implement the API for reward system such that corporate entity 140 detects and validates an action performed by a user as a qualifying trigger action such that the user is rewarded with shares for the action. In some example, corporate entity 140 can detect and validate a user's completion of a number of purchases made in a given amount of time as a qualifying trigger action. The data from corporate entity 140 can indicate that the user performed a particular user interaction other than a financial transaction. For example, if participating in a coffee capsule recycling program for coffee maker 140 is designated as a trigger action by coffee maker 140, coffee maker 140 can determine whether a user has performed a qualifying trigger action and provide details of the trigger action to reward system 110. Details of the trigger action include, for example, a description of the action itself (such as a categorization, a narrative description, etc.), a time for the action (such as the time at which the action occurred or the time at which the action qualified as a trigger action), and user information for the user who performed the qualifying trigger action.

In some implementations, corporate entity 140 can designate certain actions as qualifying trigger actions, and other devices and systems can determine whether a user has completed a qualifying trigger action. For example, if tagging corporate entity 140 through a social media application is a trigger action, user device 104 through which the user has tagged corporate entity 140 can detect the action and provide details of the action to reward system 110. In some implementations, qualifying trigger actions can include actions performed with a partner of corporate entity 140. For example, the act of volunteering at a charity event for a nonprofit for which corporate entity 140 is a sponsor can be designated as a trigger action. The nonprofit can provide participation information to corporate entity 140 for processing. In some implementations, corporate entity 140 can authorize its partner to provide this information directly to reward system 110 for processing.

In stage (A-1), reward system 110 detects a trigger action performed by a user and involving a particular corporate entity 140, such as a user transaction with corporate entity 140. For example, reward system 110 can receive transaction data from a third party data aggregator, such as data aggregator 120. In this example, the transaction data is data indicating a credit card transaction in which the user pays in-store at a POS terminal 104 for a product from corporate entity 140. In some implementations, reward system 110 retrieves data from data aggregator 120 periodically. For example, reward system 110 can retrieve transaction data from data aggregator 120 at the end of every hour, every day, every week, etc. In some implementations, reward system 110 receives data from data aggregator 120 when new data becomes available. For example, reward system 110 can receive credit card transaction data from data aggregator 120 whenever a participating user of client device 104 completes a purchase with a credit card.

In some implementations, receiving data indicating a trigger action can include receiving transaction post data indicating the transaction between the user and corporate entity 140 has posted to a user account indexed to the user's brokerage account. For example, reward system 110 can receive data indicating that a purchase made by a user from a shoe manufacturer 140 has posted to the user's credit card account or bank account that is indexed to the user's brokerage account in database 130.

In stage (A-2) reward system 110 verifies the trigger action. Reward system 110 determines whether, for example, the credit card transaction between the user and a particular corporate entity qualifies for a reward. Reward system 110 can determine whether the particular corporate entity is a participating corporate entity 140. In some implementations, reward system 110 can determine whether the particular corporate entity is designated as a participating corporate entity 140 within database 130. Reward system 110 can also determine whether the user has designated the particular corporate entity in their reward system account. In some implementations, reward system 110 will not proceed with generating a market order on behalf of the user if the trigger action is not validated.

Reward system 110 can verify the trigger action using, for example, the transaction data received in stage (A-1). This transaction data can include a corporate entity identifier, a description of the transaction (such as a category, a narrative description, etc.), an amount of the transaction, a time of transaction, etc.

In some implementations, reward system 110 can determine whether a transaction has posted to a user's financial institution account. Reward system 110 can determine, for example, that a credit card transaction with a corporate entity 140 has been initiated by a user, but has not yet posted to the user's credit card account such that funds have been subtracted. Reward system 110 can utilize a grace period between when a transaction has occurred but has not yet posted to include a portion of the transaction amount in the available funding for reward system 110 to generate market orders on behalf of users, and determine an optimal time to generate the market order to minimize the purchase price of shares included in the market order. For example, reward system 110 can detect that a transaction has occurred, and use the occurrence of the transaction as the trigger event so that algorithmic predictions can be used to determine the optimal time to place a market order.

In some implementations, reward system 110 can determine that a trigger event is not a qualifying trigger event for which a user should be rewarded. For example, if reward system 110 determines that the entity indicated in the received transaction is not a participating corporate entity 140 or that the user account is not linked to the corporate entity in database 130, reward system 110 may not proceed with generating a market order on behalf of the user.

Data flow 200 continues with stage (B), in which processor 112 determines, based on the transaction data and trigger event, a fractional number of shares of corporate entity 140 for which a market order should be generated on behalf of the user.

Reward system 110 can determine a fractional number of shares of corporate entity 140 based on the amount of the transaction. For example, a participating corporate entity 140 can specify a portion of each transaction a user makes that can be provided to the user as a reward. In one example, corporate entity 140 specifies that users will receive 1.5% of their dog toy purchase price in stock. If a user spends $100 on dog toys from corporate entity 140, the user will receive $1.50 worth of stock from corporate entity 140. Because the market fluctuates, stock prices can change based on the time at which a market order is generated. Reward system 110 can determine the fractional share of the corporate entity 140 with which to reward the user at the time of the triggering event. For example, reward system 110 can determine that the purchase price for one share of corporate entity 140 that produces travel mugs is $10 at the time that a user initiates a credit card transaction. If a user spends $25 on travel mugs through a credit card transaction with a corporate entity 140 who offers users 1% on every travel mug purchase, the user will receive $0.25 worth of stock from corporate entity 140, which, at the time of the initiation of the transaction, is 1% of a share. The purchase price for one share of corporate entity 140 may change when reward system 110 generates the market order on behalf of the user. The user will receive the fractional share that was determined by processor 112 of reward system 110 regardless of the purchase price for one share of corporate entity 140 when the market order is generated on behalf of the user. In some implementations, reward system 110 can implement minimum and/or maximum thresholds on the monetary amount from a single trigger action that can be rewarded to the user for generating a market order on behalf of the user. For example, reward system 110 can cap the amount of the fractional share rewarded to the user.

In some implementations, reward system 110 can reward users with a predetermined fractional portion of a share based on the type of trigger action the user has performed. Corporate entities 140 can map a particular user interaction to a particular fractional share factor. In some implementations, when the action is not a financial transaction, corporate entities 140 can map the interaction to a predetermined fractional portion of a share. For example, corporate entity 140 can specify that tagging corporate entity 140 in a social media post can be rewarded with 0.0001% of a share. In some implementations, the fractional share factor can be an equation with a resulting value that changes based on parameters of the detected action. For example, if a user that tags corporate entity 140 in a social media post has 100 k followers, the user may receive more of a share than if the user has 1 k followers. In some implementations, the equation can be linear with respect to certain parameters. In some implementations, the equation can be nonlinear with respect to certain parameters. For example, if a user posts a series of photos with a hashtag specified by corporate entity 140, each successive photo can be associated with an exponentially higher fractional amount of a share as a reward, up to a maximum threshold.

In some implementations, reward system 110 can determine a performance level corresponding to an amount of the particular user interaction performed by the user. Processor 112 can determine the fractional number of shares based on a mathematical operation applied to the fractional share factor and the performance level. The performance level can be a quantitative assessment. For example, reward system 110 can determine that a user has posted 16 photos, 14 of which are different, of corporate entity 140's product. Reward system 110 can reward the user, for example, only for the distinct photos, such that the performance level is 14 and the fractional share factor is multiplied by 14. In some implementations, users can earn more rewards if other users interact with their previously posted interactions. For example, if a user posts photos of corporate entity 140's athletic pants and other users interact with the photos, the user may earn more fractional amounts of shares, or may only earn rewards for those photos with which other users interacted. Reward system 110 can adjust the fractional amount of shares with which a user will be rewarded, for example, within a period of time, such as a promotional period or an evaluation period. The performance level can be a qualitative assessment. For example, reward system 110 can determine whether the user has posted a several hundred word review about one of corporate entity 140's products and has included photos (i.e., a high quality review), or whether the user has simply posted a rating of the product (i.e., a lower quality review). Reward system 110 can adjust the fractional amount of shares that a user receives based on a sliding scale of the quality of the trigger action. For example, if all participating users who perform a particular trigger action generally have high quality actions, the threshold between fractional amounts of shares that a user receives for performing the particular trigger action can be commensurately higher.

Data flow 200 continues with stage (C), in which reward system 110 determines a time to generate the market order that minimizes certain parameters of the order, including the total purchase price. For example, reward system 110 can determine an optimal time at which to place a market order for brokerage system 150 on behalf of a user of reward system 110.

In some implementations, processor 112 uses funding model 114 and/or market model 116 to determine an optimal time at which to submit the market order to market 150. Funding model 114 predicts the amount of funding available once the transaction has posted to the user's account. Market model 116 predicts the activity of market 150 and determines the optimal time to submit a market order for shares of a particular corporate entity to minimize the purchase price of shares to be obtained with the amount of the funds available.

Processor 112 of reward system 110 can detect, based on historical account data or transaction data for a user, recurring transactions between a user of reward system 110 and a particular entity 140. For example, processor 112 can determine, based on historical account data for a user, that the user has a yearly subscription for a meal delivery service that charges the user each monthly and renews yearly. Processor 112 can provide this transaction data as input to funding model 114 to predict how much funding will be available to use for generating and submitting market orders and when the funding will be available. For example, funding model 114 can determine, based on transaction and historical data, that fewer funds that needed are available for a planned market order at a particular time. Processor 112 can adjust the time at which the planned market order is generated.

Processor 112 can use the output of funding model 114 to predict an optimal time at which to generate a market order. For example, if a user has a monthly paid subscription with corporate entity 140 that is paid on the 15th of every month funding model 114 can use this historical account data, prior to the 15th of the month, to predict that the user will pay the monthly subscription fee on the 15th of the month. Processor 112 can then use market model 116 to determine an optimal time at which a market order for fractional amounts of shares will be placed to minimize the total purchase price of the market order. In some implementations, processor 112 can use the output of funding model 114 to predict an amount of funding that will be available to fund market orders to brokerage system 150. For example, processor 112 can determine that an optimal time to place a market order for shares of a particular corporate entity 140 is prior to the posting of a transaction to a user's credit card account. However, based on the historical account and transaction data for the user, funding model 114 predicts that the user will complete the monthly subscription fee transaction by the 15th, reward system 110 can generate a market order for a fractional amount of shares for the particular corporate entity 140 prior to the posting of the subscription fee to the user's credit card account. In some implementations, while reward system 110 may generate the market order for the fractional amount of shares for the particular corporate entity 140 prior to the posting of the transaction to the user's account, the reward system 110 may restrict the time period during which market orders can be generated based on any particular transaction must occur after the transaction has occurred, but may occur prior to the transaction posting.

While the rewards for trigger actions can be awarded in fractional increments, the market orders can be aggregated across reward system 110 such that market orders can be placed for whole shares of a particular corporate entity and divided into the fractional shares to be distributed among users who are to be rewarded with the shares for completing qualifying actions.

Processor 112 of reward system 110 applies machine learning models to reduce the purchase price of shares of particular corporate entities. In some implementations, reward system 110 passes the savings to users of reward system 110 by, for example, awarding them with additional fractional shares of stock. In some implementations, reward system 110 passes the savings to participating corporate entities of reward system 110 by, for example, providing the corporate entities with additional compensation.

Data flow 200 continues with stage (D), in which reward system 110 generates the market order for brokerage system 150. Reward system 110 generates, for each user with qualifying trigger actions, one or more market orders for fractional numbers of shares for brokerage system 150 at the time determined by reward system 110 in stage (C).

Reward system 110 can aggregate fractional amounts of shares for particular corporate entities 140 across all users to reduce transaction costs.

Brokerage system 150 fulfills the market order and deposits the fractional shares in each respective user's brokerage account. Brokerage system 150 provides users with fractional shares by purchasing whole shares of particular corporate entities and dividing the shares among users who are to receive fractional shares of the particular corporate entities.

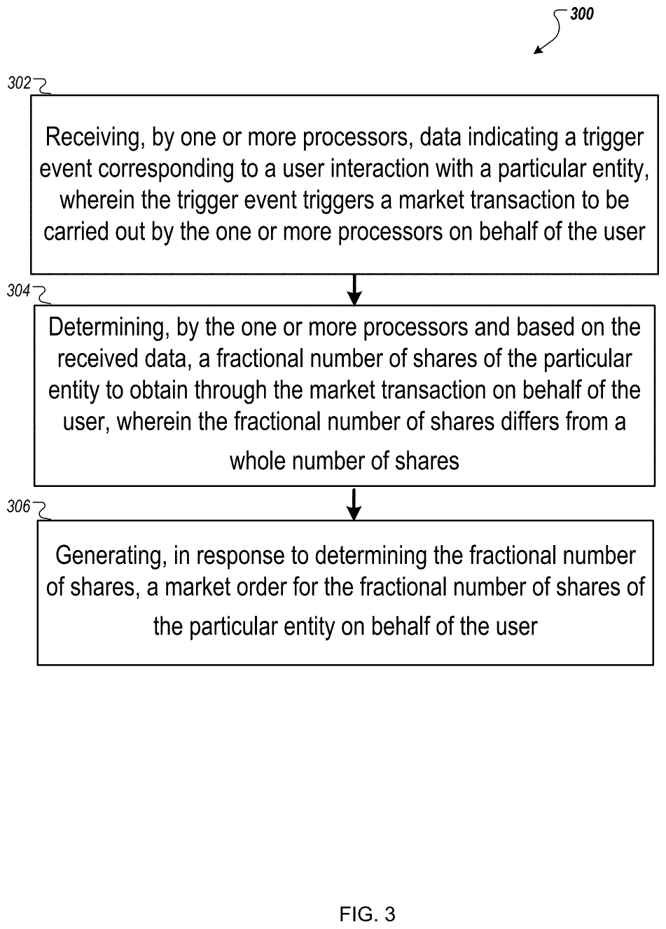

FIG. 3 is a flow chart of an example process 300 for purchasing a fractional number of shares on behalf of a user in response to a verified trigger action. In some implementations, operations of the process 300 can be implemented by a reward system. For example, operations of the process 300 can be implemented by reward system 110 of FIGS. 1-2. In some implementations, the process 300 can be implemented as instructions stored on a non-transitory computer readable medium, and when the instructions are executed by a user device, the instructions can cause the user device to perform operations of the process 300.

Process 300 begins with receiving, by one or more processors, data indicating a trigger event corresponding to a user interaction with a particular entity, wherein the trigger event triggers a market transaction to be carried out by the one or more processors on behalf of the user. For example, processor 112 of reward system 110 can receive data indicating a trigger event corresponding to a purchase transaction initiated by a reward system user through a POS terminal 104 with fruit farming corporate entity 140. The purchase transaction can be verified by reward system 110 by, for example, retrieving data from a data aggregator 120. Processor 112 of reward system 110 can determine that the purchase transaction is a qualifying trigger event by determining that (1) the user is a reward system user, (2) fruit farm 140 is a participating corporate entity, and (3) that the user has selected fruit farm 140 as an entity from which they would like to receive share rewards. The trigger event will trigger reward system 110 to generate a market order to be carried out on behalf of the user.

In some implementations, receiving data indicating a trigger event includes receiving transaction post data indicating that a transaction between the user and the particular entity has posted to a user account that is indexed to a fractional share account of the user. For example, processor 112 of reward system 110 can receive transaction post data that indicates that a credit card transaction between the user and corporate entity 140.

In some implementations, reward system 110 receives a transaction notice indicating the transaction between the user and the particular entity has occurred, but not yet posted. For example, processor 112 can receive data indicating that a credit card transaction between the user and a particular corporate entity has occurred. Upon receiving transaction post data, reward system 110 can accessing a mapping of participating entities to user accounts. For example, processor 112 can access database 130 to access mappings of corporate entities 140 to reward system user accounts. Reward system 110 can determine, based on the mapping of the participating entities to the user accounts, whether the particular entity is a participating entity, and whether the user account is linked to the particular entity in the mapping. For example, processor 112 can access database 130 and determine, based on mappings within database 130, whether the particular corporate entity is a participating corporate entity 140. Reward system 110 processes the transaction notice based on the determination of whether the particular entity is a participating entity, and whether the user account is linked to the particular entity in the mapping. Reward system 110 can trigger the market transaction when the determination reveals that the particular entity is a participating entity and that the user account is linked to the particular entity in the mapping. For example, if processor 112 determines that the particular corporate entity is a participating corporate entity 140, processor 112 can generate the market order for the fractional amount of shares of corporate entity 140. Reward system 110 can refrain from triggering the market transaction when the determination reveals that the particular entity is not a participating entity or that the user account is not linked to the particular entity in the mapping. For example, if processor 112 determines that the particular corporate entity is not a participating corporate entity 140, processor 112 will not generate a market order for the fractional amount of shares of a corporate entity.

In some implementations, reward system 110 can receive data indicating a trigger event that indicates that the user performed a particular user interaction other than a financial transaction. For example, processor 112 can receive action data that indicates that a user has participated in a recycling program specified by corporate entity 140.

Reward system 110 validates the trigger event using the data. For example, processor 112 can receive transaction data from a data aggregator, such as data aggregator 120, and validate the trigger event as described above with respect to FIG. 2. Reward system 110 can then determine that the trigger event has posted to the user's financial institution account. For example, processor 112 can receive transaction post data from data aggregator 120 that indicates that a credit card transaction trigger event has posted to the user's financial institution account. In some implementations, reward system 110 places the market order for the predetermined portion of the share of stock for the entity in response to determining that the trigger event has posted.

Process 300 continues with determining, by the one or more processors and based on the received data, a fractional number of shares of the particular entity to obtain through the market transaction on behalf of the user (304). In some implementations, the fractional number of shares differs from a whole number of shares. For example, processor 112 determines, based on the received data, a fractional number of shares of the fruit farm 140 to obtain through the market transaction on behalf of the user. The fractional number of shares is different from a whole number of shares. In some implementations, the fractional number of shares can aggregate to a whole number of shares.

In some implementation, reward system 110 determines that the particular entity has mapped the particular user interaction to a particular fractional share factor. For example, processor 112 determines that corporate entity 140 has mapped a user interaction of sharing an event posted by corporate entity 140 to a fractional share factor, such as 0.00001% of a share. Processor 112 can determine a performance level corresponding to an amount of the particular user interaction performed by the user. For example, processor 112 can determine a number of times that user shares the event. In some implementations, determining a fractional number of shares of the particular entity to obtain through the market transaction on behalf of the user comprises determining the fractional number of shares based on a mathematical operation applied to the fractional share factor and the performance level. For example, processor 112 can determine a fractional number of shares of corporate entity 140 to obtain on behalf of the user through the market transaction based on, for example, multiplying the fractional share factor and the performance level. Processor 112 can determine the fractional number of shares based on any mathematical operation applied to the fractional share factor and the performance level, including optimizing a cost function, division, etc.

In some implementations, reward system 110 determines, based on a machine learning model trained on historical account data for the user account and historical market data, a market order time at which the market order will be generated. For example, processor 112 of reward system 110 can determine, using market model 116, a time at which the market order will be generated. Market model 116 is trained on historical account data for the user account and historical market data. The market order time is after the transaction between the user and the particular entity, but before the transaction has posted to the user account. For example, processor 112 can determine a market order time after a credit card transaction between the user and corporate entity 140, but before the transaction has posted to the user's financial institution account. In some implementations, generating the market order includes generating the market order at the determined market order time.

In some implementations, reward system 110 can optionally determine, based on historical account data for the user, that there is an upcoming recurring transaction between the user and the particular entity. For example, processor 112 can determine, using funding model 114, which is trained on historical data for the user, that there is an upcoming monthly subscription fee paid by the user to corporate entity 140. Prior to the upcoming recurring transaction, reward system 110 can determine, based on a machine learning model trained on historical account data for the user account and historical market data, a market order time at which the market order will be generated, wherein the market order time is prior to the upcoming recurring transaction between the user and the particular entity. For example, processor 112 of reward system 110 can determine, using market model 116, a time at which the market order will be generated. Market model 116 is trained on historical account data for the user account and historical market data. In some implementations, generating the market order includes generating the market order at the determined market order time.

Process 300 also concludes by generating, in response to determining the fractional number of shares, a market order for the fractional number of shares of the particular entity on behalf of the user. For example, processor 112 of reward system 110 can generate, in response to determining the fractional number of shares, a market order for the fractional number of shares of the fruit farm 140 on behalf of the user. Processor 112 can use machine learning to improve the timing with which the market orders for brokerage system 150 are generated. Processor 112 can use, for example, funding model 114 and market model 116 to predict an amount of funds to become available for funding market orders and an optimal time at which to generate the market orders. Once brokerage system 150 has fulfilled the market order for the fractional amount of stock, brokerage system 150 can distribute the share rewards to individual users' brokerage accounts.

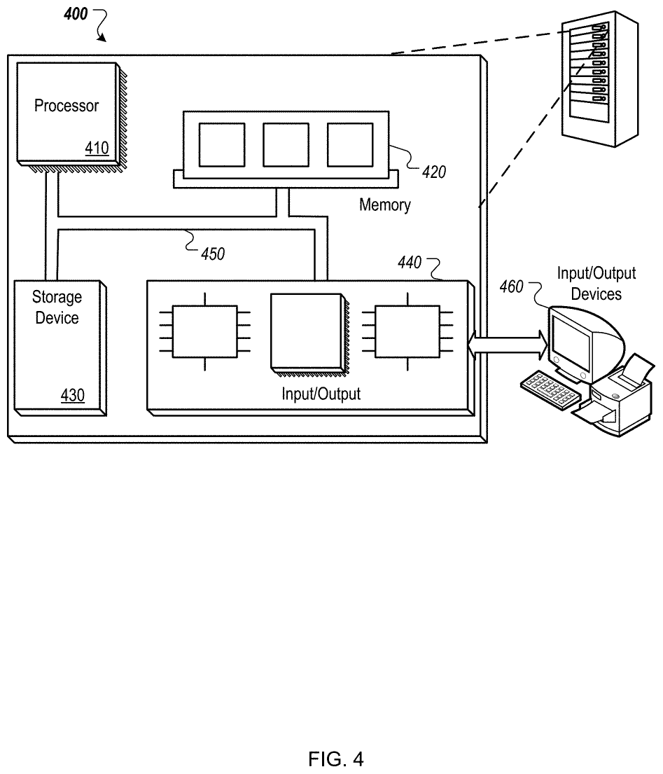

FIG. 4 is block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including, by way of example, a programmable processor, a computer, a system on a chip, or multiple ones, or combinations, of the foregoing. The apparatus can include special-purpose logic circuitry, e.g., an FPGA (field-programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special-purpose logic circuitry, e.g., an FPGA (field-programmable gate array) or an ASIC (application-specific integrated circuit).

Processors suitable for the execution of a computer program include, by way of example, both general and special-purpose microprocessors. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD ROM and DVD-ROM disks. The processor and the memory can be supplemented by, or incorporated in, special-purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, by one or more processors, data indicating a trigger event corresponding to a user interaction with a particular entity, wherein the trigger event triggers a market transaction to be carried out by the one or more processors on behalf of the user;
determining, by the one or more processors and based on the received data, a fractional number of shares of the particular entity to obtain through the market transaction on behalf of the user, wherein the fractional number of shares differs from a whole number of shares;
generating, in response to determining the fractional number of shares, a market order for the fractional number of shares of the particular entity on behalf of the user.

2. The method of claim 1, wherein receiving data indicating a trigger event comprises receiving transaction post data indicating that a transaction between the user and the particular entity has posted to a user account that is indexed to a fractional share account of the user.

3. The method of claim 2, further comprising:
receiving a transaction notice indicating the transaction between the user and the particular entity has occurred, but not yet posted;
accessing a mapping of participating entities to user accounts;
determining, based on the mapping of the participating entities to the user accounts, whether the particular entity is a participating entity, and whether the user account is linked to the particular entity in the mapping;
processing the transaction notice based on the determination of whether the particular entity is a participating entity, and whether the user account is linked to the particular entity in the mapping, including:
triggering the market transaction when the determination reveals that the particular entity is a participating entity and that the user account is linked to the particular entity in the mapping; and
not triggering the market transaction when the determination reveals that the particular entity is not a participating entity or that the user account is not linked to the particular entity in the mapping.

4. The method of claim 3, wherein triggering the market transaction comprises:
determining, based on a machine learning model trained on historical account data for the user account and historical market data, a market order time at which the market order will be placed, wherein the market order time is after the transaction between the user and the particular entity, but before the transaction has posted to the user account, wherein:
generating the market order comprises generating the market order at the determined market order time.

5. The method of claim 1, further comprising:
determining, based on historical account data for the user, that there is an upcoming recurring transaction between the user and the particular entity;
prior to the upcoming recurring transaction, determining, based on a machine learning model trained on historical account data for the user account and historical market data, a market order time at which the market order will be placed, wherein the market order time is prior to the upcoming recurring transaction between the user and the particular entity, wherein:
generating the market order comprises generating the market order at the determined market order time.

6. The method of claim 1, wherein: receiving data indicating a trigger event comprises receiving data indicating that the user performed a particular user interaction other than a financial transaction.

7. The method of claim 6, further comprising:
determining that the particular entity has mapped the particular user interaction to a particular fractional share factor;
determining a performance level corresponding to an amount of the particular user interaction performed by the user, wherein determining a fractional number of shares of the particular entity to obtain through the market transaction on behalf of the user comprises determining the fractional number of shares based on a mathematical operation applied to the fractional share factor and the performance level.

8. The method of claim 1, further comprising:
validating, by the one or more processors and using the data, the trigger event; and
determining, by the one or more processors, that the trigger event has posted to the user's financial institution account,
wherein placing the order for the predetermined portion of the share of stock for the entity is performed in response to the determination that the trigger event has posted.

9. The method of claim 1, wherein the trigger event is participation in a program specified by the entity.

10. A computer-readable storage device storing instructions that when executed by one or more processors cause the one or more processors to perform operations comprising:
receiving, by one or more processors, data indicating a trigger event corresponding to a user interaction with a particular entity, wherein the trigger event triggers a market transaction to be carried out by the one or more processors on behalf of the user;
determining, by the one or more processors and based on the received data, a fractional number of shares of the particular entity to obtain through the market transaction on behalf of the user, wherein the fractional number of shares differs from a whole number of shares;
generating, in response to determining the fractional number of shares, a market order for the fractional number of shares of the particular entity on behalf of the user.

11. The computer-readable storage device of claim 10, wherein receiving data indicating a trigger event comprises receiving transaction post data indicating that a transaction between the user and the particular entity has posted to a user account that is indexed to a fractional share account of the user.

12. The computer-readable storage device of claim 11, the operations further comprising:
receiving a transaction notice indicating the transaction between the user and the particular entity has occurred, but not yet posted;
accessing a mapping of participating entities to user accounts;
determining, based on the mapping of the participating entities to the user accounts, whether the particular entity is a participating entity, and whether the user account is linked to the particular entity in the mapping;
processing the transaction notice based on the determination of whether the particular entity is a participating entity, and whether the user account is linked to the particular entity in the mapping, including:
triggering the market transaction when the determination reveals that the particular entity is a participating entity and that the user account is linked to the particular entity in the mapping; and
not triggering the market transaction when the determination reveals that the particular entity is not a participating entity or that the user account is not linked to the particular entity in the mapping.

13. The computer-readable storage device of claim 12, wherein triggering the market transaction comprises:
determining, based on a machine learning model trained on historical account data for the user account and historical market data, a market order time at which the market order will be placed, wherein the market order time is after the transaction between the user and the particular entity, but before the transaction has posted to the user account, wherein:
generating the market order comprises generating the market order at the determined market order time.

14. The computer-readable storage device of claim 10, the operations further comprising:
determining, based on historical account data for the user, that there is an upcoming recurring transaction between the user and the particular entity;
prior to the upcoming recurring transaction, determining, based on a machine learning model trained on historical account data for the user account and historical market data, a market order time at which the market order will be placed, wherein the market order time is prior to the upcoming recurring transaction between the user and the particular entity, wherein:
generating the market order comprises generating the market order at the determined market order time.

15. The computer-readable storage device of claim 10, wherein: receiving data indicating a trigger event comprises receiving data indicating that the user performed a particular user interaction other than a financial transaction.

16. The computer-readable storage device of claim 15, further comprising:
determining that the particular entity has mapped the particular user interaction to a particular fractional share factor;
determining a performance level corresponding to an amount of the particular user interaction performed by the user, wherein determining a fractional number of shares of the particular entity to obtain through the market transaction on behalf of the user comprises determining the fractional number of shares based on a mathematical operation applied to the fractional share factor and the performance level.

17. The computer-readable storage device of claim 10, further comprising:
validating, by the one or more processors and using the data, the trigger event; and
determining, by the one or more processors, that the trigger event has posted to the user's financial institution account,
wherein placing the order for the predetermined portion of the share of stock for the entity is performed in response to the determination that the trigger event has posted.

18. The computer-readable storage device of claim 10, wherein the trigger event is participation in a program specified by the entity.

19. A system comprising:
at least one processor; and
a memory communicatively coupled to the at least one processor, the memory storing instructions which, when executed by the at least one processor, cause the at least one processor to perform operations comprising:
receiving, by one or more processors, data indicating a trigger event corresponding to a user interaction with a particular entity, wherein the trigger event triggers a market transaction to be carried out by the one or more processors on behalf of the user;
determining, by the one or more processors and based on the received data, a fractional number of shares of the particular entity to obtain through the market transaction on behalf of the user, wherein the fractional number of shares differs from a whole number of shares;
generating, in response to determining the fractional number of shares, a market order for the fractional number of shares of the particular entity on behalf of the user.

20. The system of claim 19, wherein receiving data indicating a trigger event comprises receiving transaction post data indicating that a transaction between the user and the particular entity has posted to a user account that is indexed to a fractional share account of the user, and
the operations further comprising:
receiving a transaction notice indicating the transaction between the user and the particular entity has occurred, but not yet posted;
accessing a mapping of participating entities to user accounts;
determining, based on the mapping of the participating entities to the user accounts, whether the particular entity is a participating entity, and whether the user account is linked to the particular entity in the mapping;
processing the transaction notice based on the determination of whether the particular entity is a participating entity, and whether the user account is linked to the particular entity in the mapping, including:
triggering the market transaction when the determination reveals that the particular entity is a participating entity and that the user account is linked to the particular entity in the mapping; and
not triggering the market transaction when the determination reveals that the particular entity is not a participating entity or that the user account is not linked to the particular entity in the mapping.
